(19) United States
(12) Patent Application Publication
(10) Pub. No.: US 2022/0296015 A1
(43) Pub. Date: Sep. 22, 2022

(54) DUAL VALVE BOTTLE LID

(71) Applicant: Jonathan Patrick Samuel Crane, San Diego, CA (US)

(72) Inventor: Jonathan Patrick Samuel Crane, San Diego, CA (US)

(21) Appl. No.: 17/655,490

(22) Filed: Mar. 18, 2022

Related U.S. Application Data
(60) Provisional application No. 63/200,640, filed on Mar. 19, 2021.

(51) Int. Cl. A47G 19/22; A47G 21/18; F16K 15/14

(52) U.S. Cl. CPC A47G 19/2266; A47G 21/18; F16K 15/147

(57) ABSTRACT

A dual valve bottle lid assembly includes a bottle lid; a tube coupling and a duckbill valve mounted within the bottle lid; an upper hydration tube; a mouth-activated valve; and a lower hydration tube. The tube coupling has an upper hydration tube connector and a lower hydration tube connector extending in opposite directions. A first end of the upper hydration tube is attached to the upper hydration tube connector and the lower hydration tube is attached to the lower hydration tube connector. The mouth-activated valve is attached to a second end of the upper hydration tube. The dual valve bottle bottle lid converts bottles for one handed consumption while avoiding leakage.

### CROSS-REFERENCE TO RELATED APPLICATION

This application claims the benefit of priority of U.S. provisional application No. 63/200,640, filed Mar. 19, 2021, the contents of which are herein incorporated by reference.

### BACKGROUND OF THE INVENTION

The present invention relates to bottle lids and, more particularly, to a 2-in-1 dual valve bottle lid.

Personal hydration products require users to make tradeoffs between convenience and temperature preservation, segmented between traditional bottles with varying cap types or hydration bladders, most commonly with a 36-inch tube and a mouth-actuated valve sometimes referred to as a “bite valve.” Bite-valves are normally closed and are opened when the person performs a biting action on the valve itself.

To drink, the user must remove a bottle from its storage location. While some bottles provide one-handed operation and/or thermal vacuum insulation to preserve fluid temperature, they have not been suitable for use with hydration tubes and bite valves. The rigid, non-collapsible nature of the bottle prevents effective suction through the tubes. In the absence of a collapsible bottle or container (e.g., bladder), the use of hydration tubes requires air flow into the bottle which introduces leakage risk at the point of air entry.

Hydration bladders are convenient as the user may access fluid without removing the hydration bladder from its storage location. Hydration bladders are disadvantageous as they require specialty backpacks and do not offer the thermal insulation provided by vacuum insulated steel bottles. Hydration bladders are also challenging to keep clean and sanitary due to the inaccessible nature of a largely sealed bladder.

A series of hydration tube and bite valve adapters is commercially available to fit some bottles. This product is prone to leaking due to the nature of the adapters and may result in associated personal property damage along with excessive user effort and parts storage. Further, the adapter series utilizes a straw inside of the bottle inserted into a hydration tube fitted onto the exterior of the bottle lid. The straw reduces water flow and unintentionally introduces air into the water flow so that the user consumes air with the water, leading to discomfort and burping. In addition, this product is not compatible with most market leading bottles, especially thermal vacuum insulated bottles (e.g., Hydroflask™ and Yeti™). Such products are prone to leaking because they use a series of adapters and components that are easily dislodged, risking damage to personal property (e.g., in a backpack). The exterior tube is easily disconnected from the lid and may need to be frequently re-connected.

As can be seen, there is a need for a means of eliminating the incompatibility risk of lids and for a bottle lid with an attached bite valve for one handed drinking that also provides one-way air flow into the bottle.

### SUMMARY OF THE INVENTION

In one aspect of the present invention, a dual valve bottle lid assembly is provided, comprising a bottle lid; a removable tube coupling mounted within the bottle lid, having an upper hydration tube connector and a lower hydration tube connector extending therefrom in opposite directions; an upper hydration tube having a first end and a second end, said first end being coupled with the upper hydration tube connector; a mouth-activated valve coupled with the second end of the upper hydration tube; a lower hydration tube coupled with the lower hydration tube connector; and a duckbill valve mounted within the bottle lid. In addition, the removable tube coupling, upper hydration tube, lower hydration tube, and mouth-activated valve and may be removed from the lid and replaced with a threaded cap, rendering this a 2-in-1 lid that can be used with or without the hydration tube system.

The inventive lid blends the advantages of reusable thermal vacuum insulation bottles and hydration bladders, enabling users to expand their usage of previously purchased bottles. Each lid is designed to fit commercially available bottles known in the art.

The present invention is advantageous as it provides a user a hydration product without having to choose between convenience, leak prevention, temperature preservation, and versatility, as the inventive lid system is usable with multiple bottles. The present invention also provides a construction which enhances comfort, preventing not only water leaks and spillage, but also air leaks and burping caused by swallowing air.

The inventive bottle lid enables users to convert their previously purchased bottles to be suitable for one handed consumption while avoiding leakage. The inventive lid offers the convenience of accessibility without removing the bottle from the storage location (e.g., backpack, stroller), with the added benefits of thermal insulation (in accordance with their bottle) and the ease of cleaning a more accessible bottle.

These and other features, aspects and advantages of the present invention will become better understood with reference to the following drawings, description, and claims.

### BRIEF DESCRIPTION OF THE DRAWINGS

FIG. 1 is a perspective view of a bottle lid according to an embodiment of the present invention, shown in use;

FIG. 2 is a front elevation view thereof, shown attached to a bottle;

FIG. 3 is an exploded view thereof;

FIG. 4 is a top plan view thereof;

FIG. 5 is a sectional view thereof, taken on line 5-5 of FIG. 4;

FIG. 6 is a top perspective view of a bottle lid according to another embodiment of the present invention;

FIG. 7 is a bottom perspective view thereof; and

FIG. 8 is another top perspective view thereof.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, one embodiment of the present invention is a dual valve bottle lid assembly including an embedded duckbill valve and a bite valve attached, or fluidly communicating with the bottle, by way of hydration tubes, enabling one handed drinking. The duck bill valve incorporated into the lid admits one-way air flow into the bottle without water leaking back out. The bite valve allows water to be drawn out of the bottle without introducing air into the hydration tubes.

The lower hydration tube and upper hydration tube assembly may be located at any suitable area or portion of the lid. The lower hydration tube generally has a length sufficient to extend to the interior bottom of the associated bottle. The tube is flexible so that a single long tube may be used with both short and tall bottles alike. The upper hydration tube may have any suitable length, e.g., the upper hydration tube may measure approximately 36 inches in length.

In some embodiments, the lid may have permanent hydration tube fasteners on both the top and bottom of the lid to create a sealed structure from which liquid flows freely without the introduction of air into the tube. In other embodiments, the lid may have a removable hydration tube fastener assembly which may, in some cases, also house the duckbill valve, and which seats in the lid forming an air- and water-tight seal.

In some embodiments, the upper hydration tube may be removed from the plastic lid through a screw mechanism and replaced with a leak proof cap, for example, for storage and transport.

In some embodiments, the upper hydration tube may include a silicone insulation sleeve to preserve the temperature of liquid in the hydration tube.

In some embodiments, a cap and a bite valve may be installed with a switch to enable the user to select water flow or a sealed end.

A duckbill valve generally comprises a pair of resilient lips extending from a cylindrical body that define a valve opening in a shape comparable to a duck beak. The duckbill valve may be located at any suitable area or portion of the lid.

The bite valve may be interchanged with any suitable mouth actuated valve known in the art.

A method of using the inventive lid assembly may include the following. The bottle may be filled with a beverage. The plastic lid may be screwed onto the top of the bottle such that it creates a seal on the top of the bottle, preventing liquid from exiting the bottle. The user may drink from the bottle by applying suction at the bite valve, drawing fluid from the bottle into the lower hydration tube, through the plastic lid, into the upper hydration tube, and through the bite valve. The vacuum created by this movement draws air into the bottle through the duckbill valve.

The lid assembly components may be made of any suitable food safe material by any suitable fabrication process. For example, each lid may be custom designed using three-dimensional (3D) modeling software and injection molded of food safe plastic materials. The resulting lid may be assembled with commercially available gaskets, hydration tubes, and bite valves. The lower hydration tube at the bottom of the bottle may be cut at a 45-degree angle.

The inventive lid may be assembled in the following manner. The duck bill valve may be installed into a plastic lid or into a tube coupling having, on the top and on the bottom thereof, a tube fastener. A rubber gasket may be attached on the inner perimeter of the plastic lid. A lower hydration tube may be installed to a fastener on the bottom of the lid. An upper hydration tube may be installed to a fastener on the top of the plastic lid. The bite valve may be installed at the free end of the upper hydration tube.

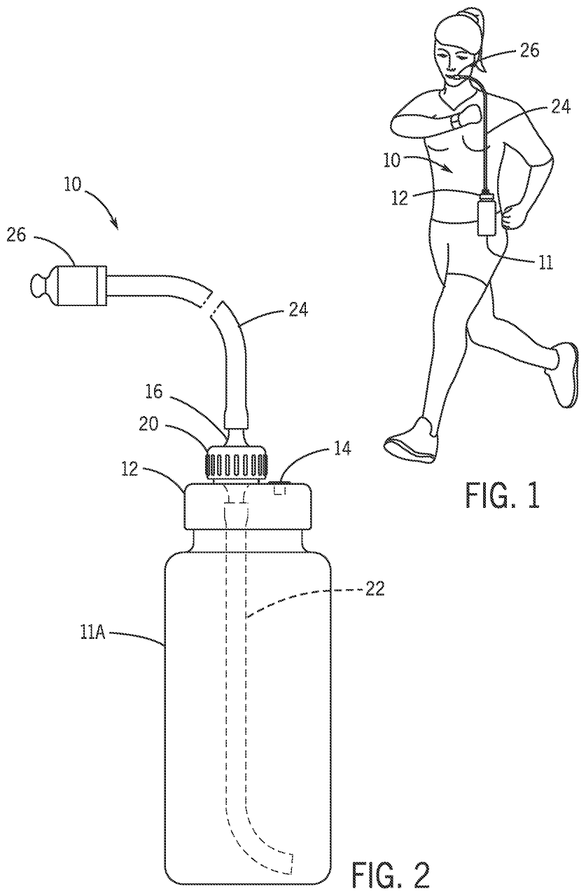

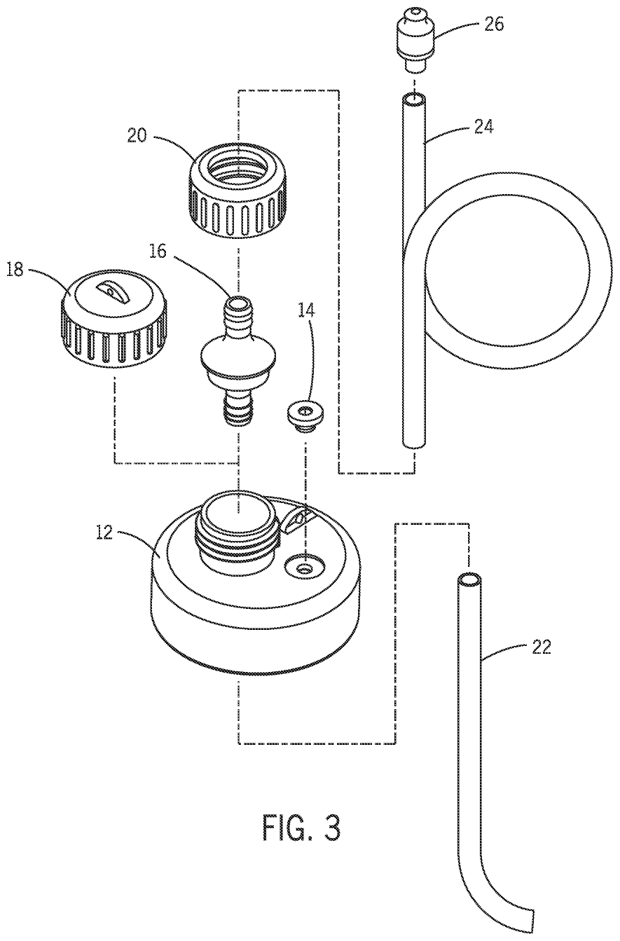

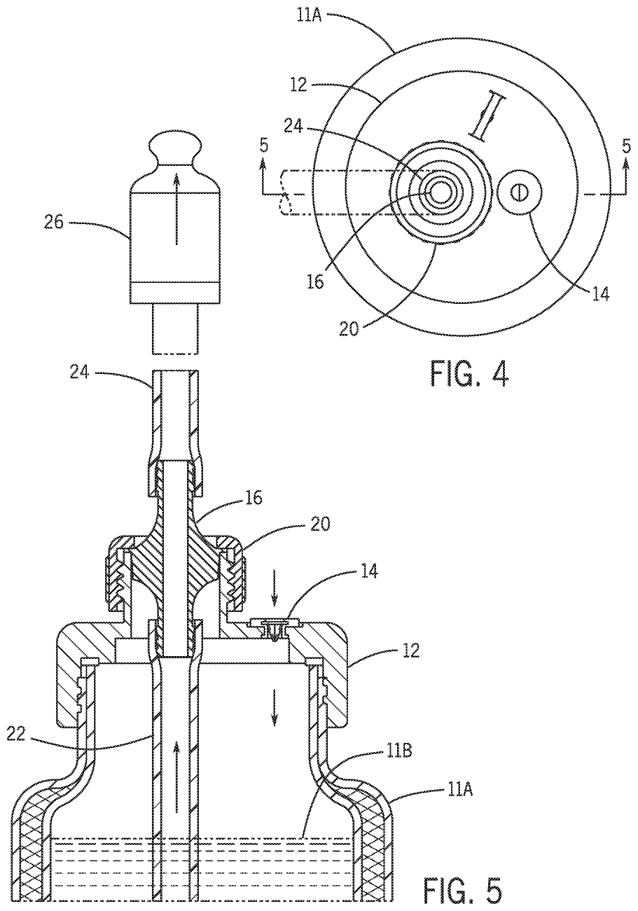

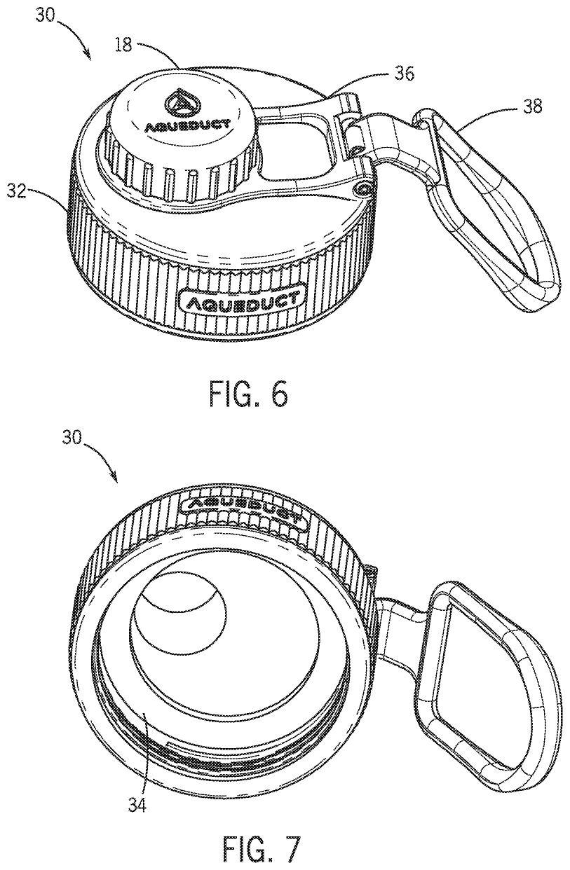

Referring to FIGS. 1 through 7, FIGS. 1 and 2 show a bottle lid assembly 10 according to an embodiment of the present invention attached to a commercially available bottle 11A containing a beverage 11B. As shown in FIG. 5, the bottle 11A may have vacuum walls to thermally insulate the beverage 11B. As more clearly shown in FIG. 3, the bottle lid assembly 10 comprises a lid 12 with a duck bill valve 14 seated in a first aperture, a tube coupling or pass-through gasket 16 seated in a second aperture with a lower tube 22 and an upper tube 24 attached thereto, and a bite valve 26 attached at an opposite end of the upper tube 24. The pass-through gasket 16 has a barbed portions to which each of the tubes 22, 24 attach and may be held in place with a threaded collar ring 20. When not in use, the pass-through gasket 16 may be removed from the lid 12 and a closed cap 18 may be screwed on in place of the collar ring 20. FIG. 5 illustrates the operation of the bottle lid assembly 10, in which the beverage 11B is drawn up through the bite valve 26 and is replaced with air entering through the duck bill valve 14.

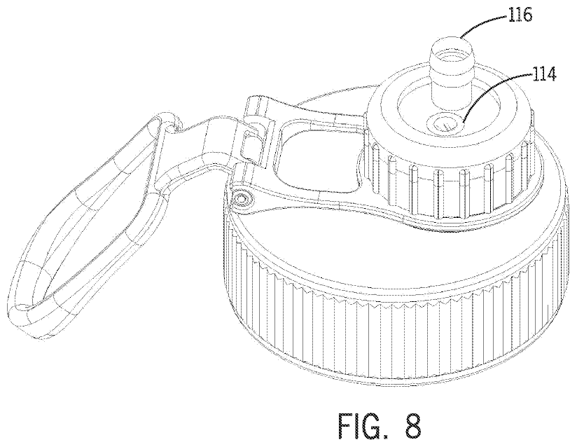

In an alternate embodiment, the duck bill valve 14 may be installed into the pass-through gasket 16 or otherwise merged therewith such that a bottle lid 30 having a single aperture may be used. This alternate embodiment reduces the risk of temperature loss when the tube 24 and bite valve 26 are not in use. The lid 30 may have a silicone grip 32 around the outer circumference and an inner gasket 34 to form a seal with the bottle 11B. The closed cap 18 may be installed on a swing arm 36 hingedly attached to the lid 30 with a hinged handle 38. As shown in FIG. 8, the lid 30 may have a pass-through gasket 116 seated in an aperture thereof. A duck bill valve 114 is shown formed in or embedded in the pass-through gasket 114, obviating the need for a dedicated aperture in the lid 30.

It should be understood, of course, that the foregoing relates to exemplary embodiments of the invention and that modifications may be made without departing from the spirit and scope of the invention as set forth in the following claims.

What is claimed is:

1. A dual valve bottle lid assembly comprising:
a bottle lid;
a tube coupling mounted within the bottle lid, having an upper hydration tube connector and a lower hydration tube connector extending therefrom in opposite directions;
an upper hydration tube having a first end and a second end, said first end being coupled with the upper hydration tube connector;
a mouth-activated valve coupled with the second end of the upper hydration tube;
a lower hydration tube coupled with the lower hydration tube connector; and
a duckbill valve mounted within the bottle lid.

2. The dual valve bottle lid assembly of claim 1, further comprising an insulation sleeve encircling the upper hydration tube.

3. The dual valve bottle lid assembly of claim 1, further comprising a collar ring threadedly couplable with the bottle lid around the tube coupling.

4. The dual valve bottle lid assembly of claim 1, further comprising a silicone grip formed around an outer circumference of the bottle lid.

5. The dual valve bottle lid assembly of claim 1, further comprising a gasket lining an inner circumference of the bottle lid.

6. The dual valve bottle lid assembly of claim 1, further comprising a handle hingedly attached to the bottle lid.

7. The dual valve bottle lid assembly of claim 1, further comprising a cap couplable with the bottle lid.

8. The dual valve bottle lid assembly of claim 7, wherein the cap is mounted to a swing arm hingedly attached to the bottle lid.

9. The dual valve bottle lid assembly of claim 1, wherein the duckbill valve is formed in the tube coupling.
